(19) United States
(12) Patent Application Publication
(10) Pub. No.: US 2012/0007788 A1
(43) Pub. Date: Jan. 12, 2012

(54) ANTENNA MODULE

(76) Inventor: Guo-Zhi Hung, Kaohsiung (TW)

(21) Appl. No.: 12/975,300

(22) Filed: Dec. 21, 2010

(30) Foreign Application Priority Data
Jul. 8, 2010 (TW) 099122402

(51) Int. Cl. H01Q 1/52

(52) U.S. Cl. 343/851

(57) ABSTRACT

An antenna module is provided. The antenna module is disposed in an electronic device. The antenna module includes an antenna, a signal processing unit, a first differential mode transformer, a first coaxial cable, and a second coaxial cable. The differential mode transformer is electrically connected between the antenna and the signal processing unit. The first coaxial cable includes first conductive core and first tubular conductor which encompasses the first conductive core. The signals received by the antenna are fed into first end of the first conductive core, and second end of the first conductive core is coupled to the differential mode transformer. The first tubular conductor is grounded. The second coaxial cable includes a second conductive core and a second tubular conductor which encompasses the second conductive core. A second end of the second conductive core is connected to the differential mode transformer. The second tubular conductor is grounded.

### FIELD OF INVENTION

The invention relates to an antenna module, and especially relates to an antenna module having improved electromagnetic compatibility.

### BACKGROUND OF THE INVENTION

Electromagnetic compatibility (EMC) is defined as the capability of systems or equipments to be tested under the intended electromagnetic environment at designed requirements without excessive electromagnetic interference to other electronic equipments. Therefore, electromagnetic compatibility involves two different kinds of requirements. One of these two requirements is the maintaining of a tolerable amount of electromagnetic interference created by an electrical equipment to the environment to be kept under a specified limit, while the other requirement is electromagnetic susceptibility, which refers to the continued proper operation of the electrical equipment under a specified level in the presence of various unplanned electromagnetic disturbances.

Please refer to FIG. 1. FIG. 1 is a schematic diagram which shows the structure of a conventional antenna module. The antenna module 1200 is disposed in an electrical device, such as a notebook computer. The antenna module 1200 includes an antenna 1210, a coaxial cable 1240, and a signal processing unit 1220. The antenna 1210 is used to receive a plurality of wireless signals. The wireless signals received by the antenna 1210 are passed through the coaxial cable 1240, and transmitted into the signal processing unit 1220. The signal processing unit 1220 converts the received wireless signals into other types of signals that the other electronic components inside the notebook computer are able to process.

Please refer to FIG. 1 and FIG. 2. FIG. 2 is a schematic diagram which shows the structure of a coaxial cable 1240. The coaxial cable 1240 includes a conductive core 1246, a dielectric layer 1244, a tubular conductor 1248, and an outer sheath 1242. The electrical potential or voltage of the signals transmitted by the conductive core 1246 is opposite to that of the signals transmitted by the tubular conductor 1248. For example, the conductive core 1246 carries the positive voltage signals while the tubular conductor 1248 carries the negative voltage signals, or the conductive core 1246 carries the negative voltage signals while the tubular conductor 1248 carries the positive voltage signals. However, the electromagnetic waves from other electronic devices in the ambient environment still have the potential to interfere with the signals transmitted by the coaxial cable 1240. For example, if the notebook computer with the antenna module 1200 is placed near a television, the electromagnetic waves radiated from the television may be received by the antenna 1210 so as to cause a plurality of noise signals. Furthermore, at a bending portion of the coaxial cable 1240 or when a breakage occurs at the tubular conductor 1248, the coaxial cable 1240 then radiates or receives electromagnetic waves to and from the outside environment, thus causing electromagnetic interference with other electronic components or systems.

Hence, there is a need in the art for designing an antenna module having improved electromagnetic compatibility.

### SUMMARY OF THE INVENTION

One object of the present invention is to provide an antenna module having improved electromagnetic compatibility.

To achieve the foregoing and other object, an antenna module is disclosed. The antenna module is disposed in an electronic device. The antenna module includes an antenna, a signal processing unit, a first differential mode tranformer, a first coaxial cable, and a second coaxial cable. The first differential mode transformer is electrically connected between the antenna and the signal processing unit. The first coaxial cable includes a first conductive core and a first tubular conductor which surrounds the first conductive core, and the second coaxial cable includes a second conductive core and a second tubular conductor which surrounds the second conductive core. A plurality of signals received by the antenna is fed into a first end of the first conductive core. A second end of the first conductive core is connected to the first differential mode tranformer, while a second end of the second conductive core is connected to the first differential mode transformer. The first tubular conductor and the second tubular conductor are grounded.

In the antenna module, the antenna is a dipole antenna. The dipole antenna includes a first antenna and a second antenna. The signals received by the first antenna are fed into the first end of the first conductive core, and the signals received by the second antenna are fed into the first end of the second conductive core.

In the antenna module, the antenna is a monopole antenna. The signals received by the monopole antenna are fed into the first end of the conductive core, and the first end of the second conductive core is grounded.

The antenna module further includes a second differential mode transformer. The second differential mode transformer is connected in series with the first differential mode transformer. The first differential mode transformer is electrically connected with the signal processing unit via the second differential mode transformer. The noise suppression frequency band of the first differential mode transformer is different from that of the second differential mode transformer.

The antenna module further includes another second differential mode transformer. The second differential mode transformer is connected in series with the first differential mode transformer. The first differential mode transformer is electrically connected with the signal processing unit via the second differential mode transformer. The noise suppression frequency band of the first differential mode transformer is identical to that of the second differential mode transformer.

In the antenna module, the first differential mode transformer includes a first coil and a second coil. Two ends of the first coil are connected to the second end of the first conductive core and the second end of the second conductive core, respectively, while two ends of the second coil are connected to the signal processing unit.

In the antenna module, the antenna is a monopole antenna. The monopole antenna is connected to the first end of the first conductive core. The first end of the second conductive core is grounded. The first differential mode transformer includes a first coil and a second coil. One end of the first coil is connected to the second end of the first conductive core, while the other end of the first coil is connected to the signal processing unit. One end of the second coil is connected to the second end of the second conductive core, while the other end of the second coil is connected to the signal processing unit.

Because the first conductive core and the second conductive core are each shielded by the first tubular conductor and the second tubular conductor, respectively, the antenna module has better or improved electromagnetic compatibility.

To achieve the foregoing and other object, another embodiment of an antenna module is disclosed. The antenna module is disposed in a printed circuit board. The printed circuit board has a multi-layer structure and includes a top metal layer, a middle metal layer, and a bottom metal layer. The antenna module includes an antenna, a first differential mode transformer, a signal processing unit, and a conductive line. The antenna is formed in the top metal layer. The first differential mode transformer is formed in the top metal layer. The signals received by the antenna are fed into the first differential mode transformer. The signal processing unit is disposed on the top metal layer. The conductive line is formed in the middle metal layer. One end of the conductive line is electrically connected to the first differential mode transformer, while the other end of the conductive line is electrically connected to the signal processing unit.

The antenna module further includes an electrical connecting interface.

The antenna module further includes a metal shield. The metal shield is disposed on the top metal layer, and shields the first differential mode transformer and the signal processing unit.

The conductive line is formed in the middle metal layer, so that it is shielded by the top metal layer and the bottom metal layer. Therefore, the signals transmitted by the conductive line are not easily interfered with by the electromagnetic waves from the external ambient environment.

The above and other aspects, features, and advantages of the present invention will become more apparent from the following detailed description when taken in conjunction with the accompanying drawings.

### BRIEF DESCRIPTION OF THE DRAWINGS

FIG. 1 is a schematic diagram which shows the structure of a conventional antenna module.

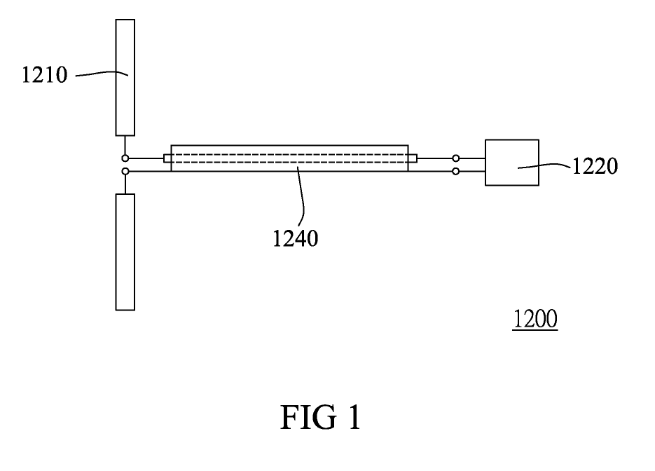

FIG. 2 is a schematic diagram which shows the structure of a coaxial cable.

FIG. 3 is a schematic diagram which shows an antenna module of a first embodiment of the present invention.

FIG. 4 is a schematic diagram which shows the first differential mode transformer in more detail.

FIG. 5 is a schematic diagram which shows an antenna module of a second embodiment of the present invention.

FIG. 6 is a schematic diagram which shows an antenna module of a third embodiment of the present invention.

FIG. 7 is a schematic diagram which shows an antenna module of a fourth embodiment of the present invention.

FIG. 8 is a schematic diagram which shows an antenna module of a fifth embodiment of the present invention.

FIG. 9 is a cross-sectional view of the antenna module shown in FIG. 8.

### DETAILED DESCRIPTION OF THE INVENTION

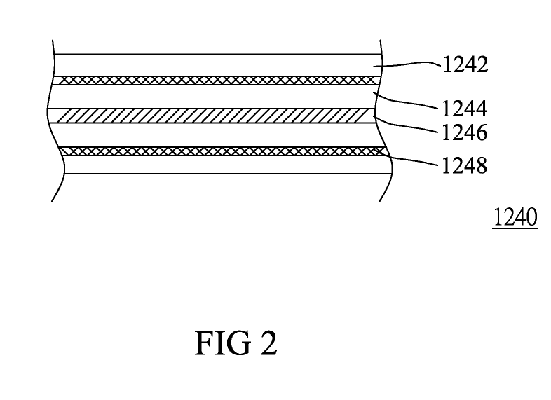

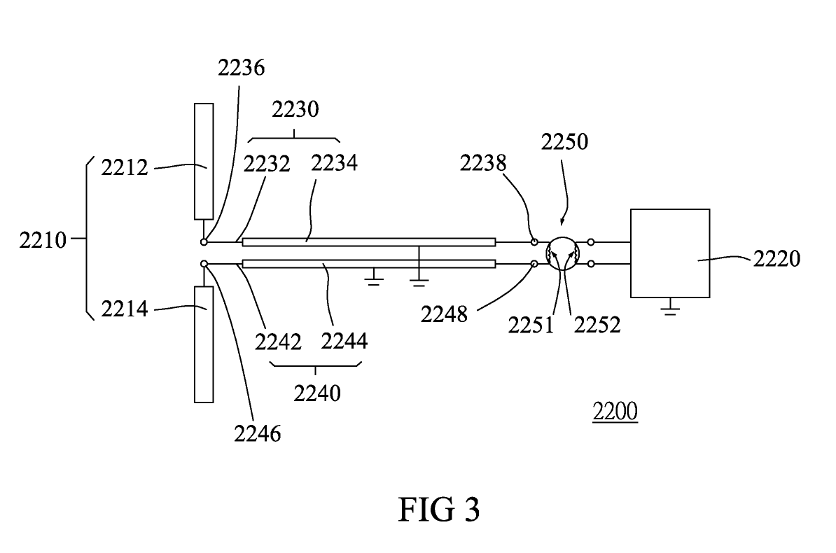

Please refer to FIG. 3. FIG. 3 is a schematic diagram which shows an antenna module of a first embodiment of the present invention. The antenna module 2200 is disposed in an electrical device (not shown) such as a notebook computer, a desktop computer, or a cell phone. The antenna module 2200 includes an antenna 2210, a signal processing unit 2220, a first coaxial cable 2230, a second coaxial cable 2240, and a first differential mode transformer 2250. The antenna 2210 is used to receive a plurality of wireless signals. The signal processing unit 2220 is used for converting the wireless signals received by the antenna 2210 into other types of signals that other electronic components in the notebook computer can process. The first coaxial cable 2230 includes a first conductive core 2232 and a first tubular conductor 2234. The second coaxial cable 2240 includes a second conductive core 2242 and a second tubular conductor 2244. The first tubular conductor 2234 and the second tubular conductor 2244 are, for example, woven by a plurality of copper wires. Similar to the coaxial cable 1240 shown in FIG. 2, both the first tubular conductor 2234 and the second tubular conductor 2244 also includes a dielectric layer and an outer sheath (not shown for the sake of brevity).

In the present embodiment, the antenna 2210 is a dipole antenna which includes a first antenna 2212 and a second antenna 2214. The signals received by the first antenna 2212 are fed into the first end 2236 of the first conductive core 2232. The signals received by the second antenna 2214 are fed into the first end 2246 of the second conductive core 2242. The voltage of the signals carried by the first conductive core 2232 is opposite to that of the signals carried by the second conductive core 2242, that is to say, the voltage of the signals carried by the first conductive core 2232 is positive voltage, while the voltage of the signals carried by the second conductive core 2242 is a negative voltage.

Please refer to FIG. 3. The first tubular conductor 2234 of the first coaxial cable 2230 and the second tubular conductor 2244 of the second coaxial cable 2240 are grounded. Therefore, the noise signals radiated from the first conductive core 2232 and the second conductive core 2242 are shielded so as not to interfere with other electronic devices in the external ambient environment. In addition, the electromagnetic waves from the external ambient environment are shielded by the first tubular conductor 2234 and the second tubular conductor 2244, thus the noise signals from the external environment are thereby less prone to being coupled into the first conductive core 2232 and the second conductive core 2242.

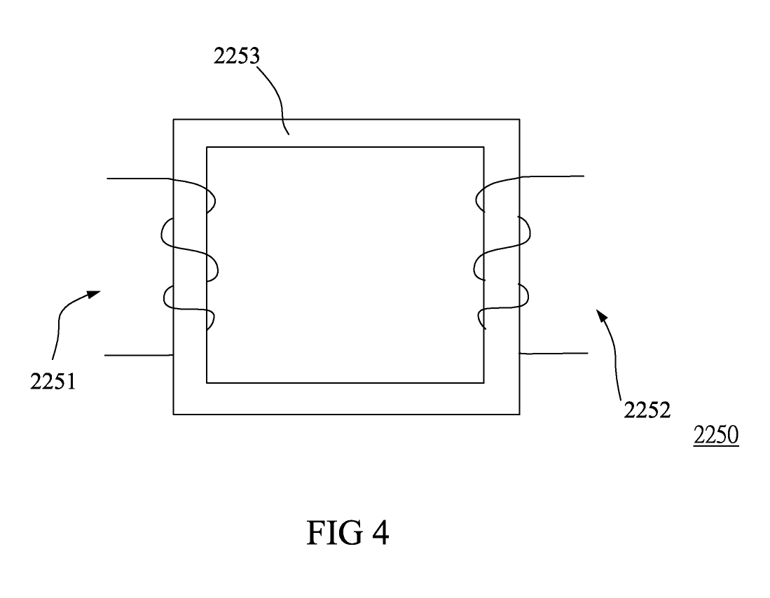

The second end 2238 of the first conductive core 2232 and the second end 2248 of the second conductive core 2242 are connected to the first differential mode transformer 2250. By using electromagnetic induction, the first differential mode transformer 2250 suppresses a plurality of common mode noise signals, instead of that of differential mode noise signals. Please refer to FIG. 3 and FIG. 4. FIG. 4 is a schematic diagram which shows the first differential mode transformer 2250 in more details. The first differential mode transformer 2250 includes a first coil 2251, a second coil 2252, and a magnetic core 2253. The winding direction of the first coil 2251 is opposite to that of the second coil 2252, so that the common mode noise signals can be suppressed or eliminated. The material of the magnetic core 2253 is ferrites. By changing the material of the magnetic core 2253 or the number of turns of the first coil 2251 and the second coil 2252, the noise suppression frequency band of the first differential mode transformer 2250 can be adjusted. In this embodiment, the noise suppression frequency band of the first differential mode transformer 2250 is between 600 Mhz to 900 Mhz.

Because the first conductive core 2232 and the second conductive core 2242 are each shielded by the first tubular conductor 2234 and the second tubular conductor 2244, respectively, the antenna module 2200 has better electromagnetic compatibility. Furthermore, the first differential mode transformer 2250 can eliminate or suppress the common mode noise signals, so that the noise signals received by the signal processing unit 2220 are thereby decreased.

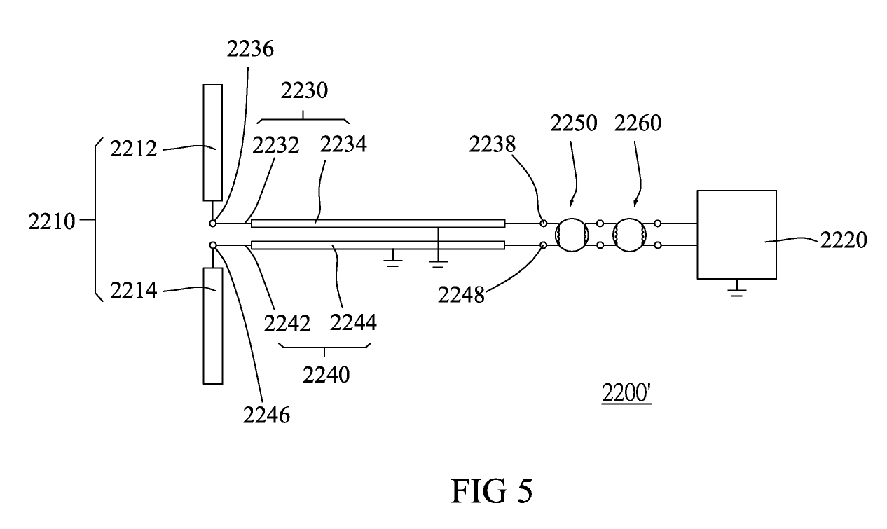

Please refer to FIG. 5. FIG. 5 is a schematic diagram which shows an antenna module of a second embodiment of the present invention. Compared to the antenna module 2200, the antenna module 2200′ further includes a second differential mode transformer 2260. The second differential mode transformer 2260 is connected with the first differential mode transformer 2250 in series. In this embodiment, the noise suppression frequency bands of the first differential mode transformer 2240 and the second differential mode transformer 2260 are identical to each other. As a result, the antenna module 2200′ has improved noise suppressing effect.

The noise suppression frequency band of the second differential mode transformer 2260 can be different from that of the first differential mode transformer 2250. For example, the noise suppression frequency band of the first differential mode transformer 2250 is between 600 Mhz to 900 Mhz, and the noise suppression frequency band of the second differential mode transformer 2260 is between 1800 Mhz to 2100 Mhz. Thus, the antenna module 2200′ can be disposed in a dual-band mobile phone. Furthermore, a person of ordinary skill in the art can connect more differential mode transformer in series depending upon the particular requirements.

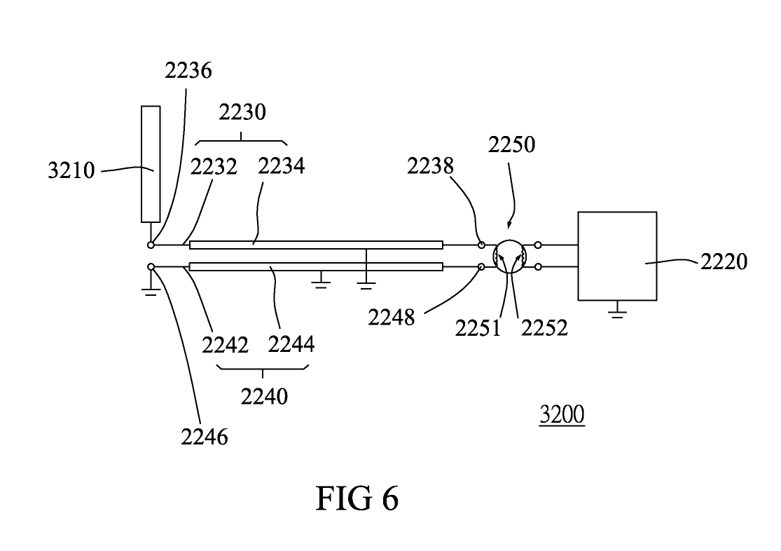

In the above-described first and second embodiments, the antennas both are dipole antennas. However, a person of ordinary skill in the art should understand that the antenna can be designed as a monopole antenna. Please refer to FIG. 6. FIG. 6 is a schematic diagram which shows an antenna module of a third embodiment of the present invention. Compared to the antenna 2200, an antenna 3210 of an antenna module 3210 is a monopole antenna. The signals received by the antenna 3210 are fed into the first end 2236 of the first conductive core 2232, and the first end 2246 of the second conductive core 2242 is grounded. The other components in the antenna module 3200 are identical to that of the antenna module 3200, so that the detailed description of these components is omitted for brevity.

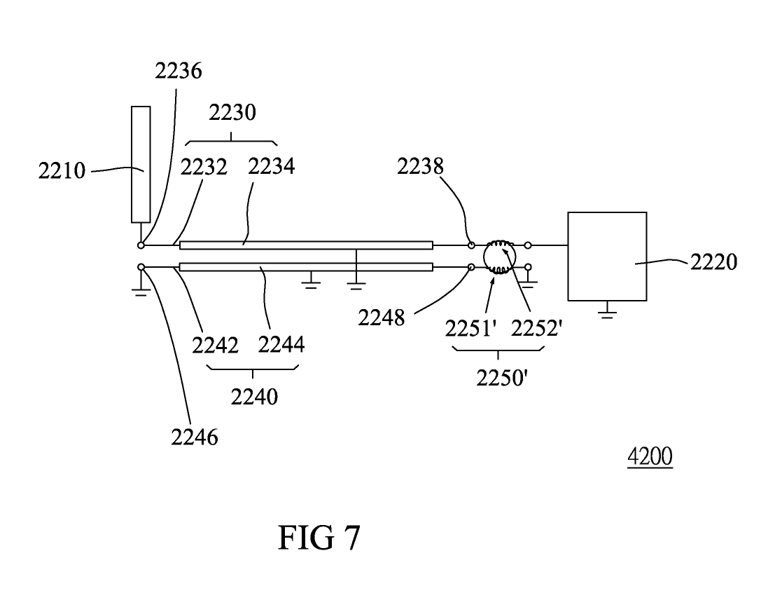

In addition, if the antenna is a monopole antenna, the connection method of the coil in the differential mode transformer can take on a plurality of different methods. Please refer to FIG. 7. FIG. 7 is a schematic diagram which shows an antenna module of a fourth embodiment of the present invention. The connection method of a coil in a first differential mode transformer 2250′ of an antenna module 4200 is different from that in the first differential mode transformer 2250 of the antenna module 3200. The first differential mode transformer 2250′ includes a first coil 2251′ and a second coil 2252′. One end of the first coil 2251′ is connected to the second end 2248 of the second conductive core 2240, while the other end of the first coil 2251′ is grounded. One end of the second coil 2252′ is connected to the second end 2238 of the first conductive core 2230, while the other end of the second coil 2252′ is connected to the signal processing unit 2200. The winding direction of the first coil 2251′ is opposite to that of the second coil 2252′, so that the common mode noise signals can be suppressed or eliminated.

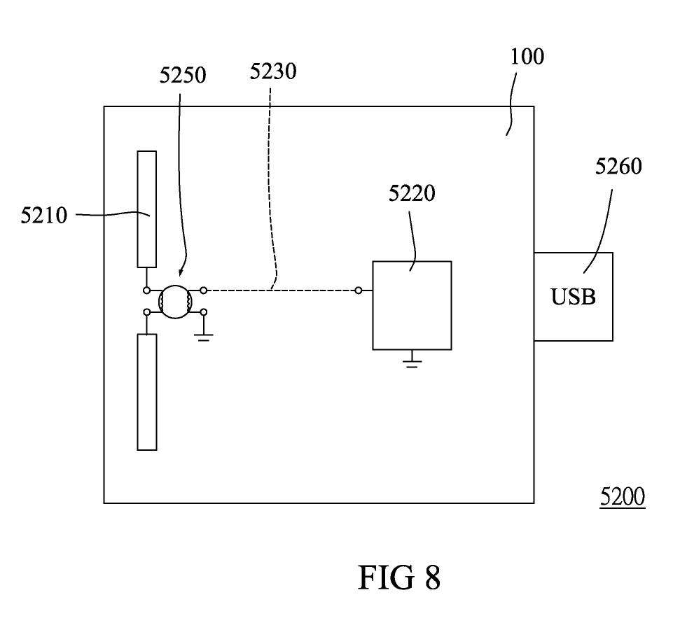

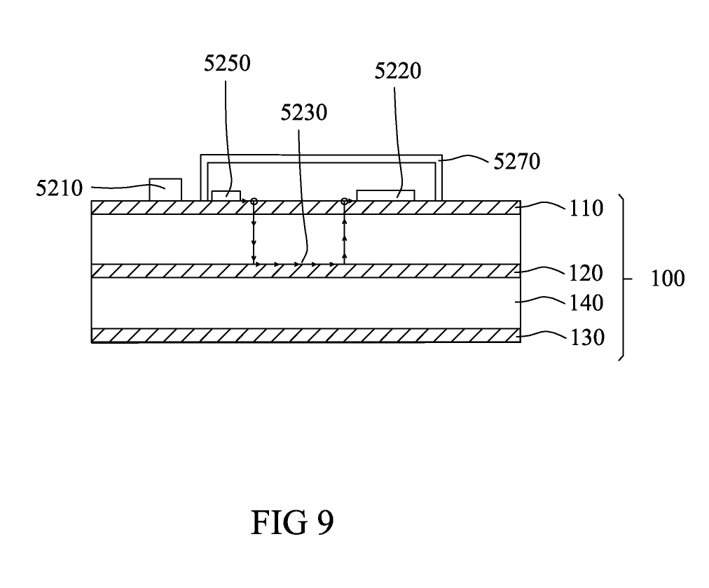

Please refer to FIG. 8 and FIG. 9. FIG. 8 is a schematic diagram which shows an antenna module of a fifth embodiment of the present invention. FIG. 9 is a cross-sectional view of the antenna module in FIG. 8. An antenna module 5200 is disposed in a printed circuit board 100. The printed circuit board 100 has a multi-layered structure. The printed circuit board 100 includes a plurality of metal layers, i.e. a top metal layer 110, a middle metal layer 120, and a bottom metal layer 130. A dielectric layer 140 is disposed between each of the metal layers. The antenna module 5200 includes an antenna 5210, a first differential mode transformer 5250, a signal processing unit 5220, and a conductive line 5230. The antenna 5220 and the first differential mode transformer 5250 are both formed in the top metal layer 110. The signals received by the antenna 5220 are fed into the first differential transformer transformer 5250. The signal processing unit 5220 is disposed on the top metal layer 110. The conductive line 5230 is formed in the middle metal layer 120. One end of the conductive line 5230 is connected to the first differential mode transformer 5250, while the other end of the conductive line 5230 is connected to the signal processing unit 5220.

Furthermore, a metal shield 5270 is disposed on the top layer 110. The metal shield 5270 shields the first differential mode transformer 5250 and the signal processing unit 5220. By having the metal shield 5270, the first differential mode transformer 5250 and the signal processing unit 5220 can be prevented from being interfered with by the electromagnetic wave from external ambient environment. The antenna module 5200 further includes an electrical connecting interface 5260 such as an USB connector. Therefore, after the electrical connecting interface 5260 of the antenna module 5200 is inserted into an electronic device such as a notebook computer, the electronic device will be able to receive and broadcast wireless signals.

In FIG. 9, a plurality of arrow symbols indicates the direction of the transmitting signal. First, the signals received by the antenna 5210 are fed into the first differential mode transformer 5250. After the common mode noise signals are suppressed by the first differential mode transformer 5250, the signals are passed through the conductive line 5230 and transmitted into the signal processing unit 5220. The conductive line 5230 is formed in the middle metal layer 120, so that it is shielded by the top metal layer 110 and the bottom metal layer 130. Therefore, the signals transmitted by the conductive line 230 are not easily interfered with by the electromagnetic wave from the external ambient environment.

In the above described embodiments, the dipole antenna and the monopole antenna are used as the embodiments of the antenna However, a person of ordinary skill in the art can opt to design the antenna as of other types, for example, such as a PITA antenna.

Although the description above contains many specifics, these are merely provided to illustrate the invention and should not be construed as limitations of the invention's scope. Thus it will be apparent to those skilled, in the art that various modifications and variations can be made in the system and processes of the present invention without departing from the spirit or scope of the invention.

What is claimed is:

1. An antenna module, disposed in an electronic device, the antenna module comprising:
an antenna;
a signal processing unit;
a first differential mode transformer, the first differential mode transformer electrically connected between the antenna and the signal processing unit;
a first coaxial cable, the first coaxial cable comprising a first conductive core and a first tubular conductor, and the first tubular conductor surrounding the first conductive core; and
a second coaxial cable, the second coaxial cable comprising a second conductive core and a second tubular conductor, and the second tubular conductor surrounding the second conductive core;
wherein a plurality of signals received by the antenna is fed into a first end of the first conductive core, a second end of the first conductive core is connected to the first differential mode transformer, a second end of the second conductive core is connected to the first differential mode transformer, and the first tubular conductor and the second tubular conductor are grounded.

2. The antenna module of claim 1, wherein the antenna is a dipole antenna, the dipole antenna comprises a first antenna and a second antenna, the signals received by the first antenna are fed into the first end of the first conductive core, and the signals received by the second antenna are fed into the first end of the second conductive core.

3. The antenna module of claim 1, wherein the antenna is a monopole antenna, the signals received by the monopole antenna are fed into the first end of the first conductive core, and the first end of the second conductive core is grounded.

4. The antenna module of claim 1, further comprising a second differential mode transformer, wherein the second differential mode transformer is connected in series with the first differential mode transformer, and the first differential mode transformer is electrically connected with the signal processing unit via the second differential mode transformer, and the noise suppression frequency band of the first differential mode transformer and that of the second differential mode transformer are different from each other.

5. The antenna module of claim 1, further comprising a second differential mode transformer, wherein the second differential mode transformer is connected in series with the first differential mode transformer, the first differential mode transformer is electrically connected with the signal processing unit via the second differential mode transformer, and the noise suppression frequency bands of the first differential mode transformer and that of the second differential mode transformer are identical to each other.

6. The antenna module of claim 1, wherein the first differential mode transformer comprises a first coil and a second coil, two ends of the first coil are each connected to the second end of the first conductive core and the second end of the second conductive core, respectively, and two ends of the second coil are connected to the signal processing unit.

7. The antenna module of claim 1, wherein the antenna is a monopole antenna, the monopole antenna is connected to the first end of the first conductive core, the first end of the second conductive core is grounded, the first differential mode transformer comprises a first coil and a second coil, one end of the first coil is connected to the second end of the first conductive core, and the other end of the first coil is connected to the signal processing unit, one end of the second coil is connected to the second end of the second conductive core, and the other end of the second conductive core is connected to the signal processing unit.

8. An antenna module, disposed in a printed circuit board, the printed circuit board having a multi-layered structure, and the printed circuit board comprising a top metal layer, a middle metal layer, and a bottom metal layer, the antenna module comprising:
an antenna, the antenna formed in the top metal layer;
a first differential mode transformer, the first differential mode transformer formed in the top metal layer, and the signals received by the antenna fed into the first differential mode transformer;
a signal processing unit, the signal processing unit disposed on the top metal layer; and
a conductive line;
wherein the conductive line is formed in the middle metal layer, and one end of the conductive line is electrically connected to the first differential mode transformer, and the other end of the conductive line is electrically connected to the signal processing unit.

9. The antenna module of claim 8, further comprising an electrical connecting interface.

10. The antenna module of claim 8, further comprising a metal shield, wherein the metal shield is disposed on the top metal layer, and the metal shield is shielding the first differential mode transformer and the signal processing unit.
